(19) United States
(12) Patent Application Publication
(10) Pub. No.: US 2017/0108984 A1
(43) Pub. Date: Apr. 20, 2017

(54) TOUCH PANEL CONTROLLER, TOUCH PANEL SYSTEM, AND STYLUS PEN

(71) Applicant: Sharp Kabushiki Kaisha, Osaka (JP)

(72) Inventors: Mamoru TAKAYA, Osaka (JP); Michiaki TAKEDA, Osaka (JP); Takahiro KATAYAMA, Osaka (JP)

(73) Assignee: SHARP KABUSHIKI KAISHA, Sakai City, Osaka (JP)

(21) Appl. No.: 15/311,876

(22) PCT Filed: May 19, 2015
(86) PCT No.: PCT/JP2015/064355

§ 371 Date: Nov. 17, 2016

(30) Foreign Application Priority Data
Jun. 30, 2014 (JP) 2014-135315

(51) Int. Cl. G06F 3/041; G06F 3/0354; G06F 3/044

(52) U.S. Cl. CPC G06F 3/0416; G06F 3/044; G06F 3/03545; G06F 2203/04105

(57) ABSTRACT

Provided is a touch panel system capable of minimizing the possibility of a stylus pen failing to detect a synchronization signal. A touch panel controller (4) in the touch panel system generates a preparation signal including a high state and a low state that acts as a reference for adjusting the reception sensitivity of the synchronization signal in the stylus pen, and outputs the preparation signal to the touch panel earlier than the timing at which to output the synchronization signal to the touch panel.

### TECHNICAL FIELD

The present invention relates to a touch panel controller that outputs, to a touch panel, a synchronization signal acquired at a certain timings by a stylus pen, a stylus pen that acquires a touch panel synchronization signal at a certain timing, and a touch panel system equipped with a stylus pen, a touch panel controller, and a touch panel.

### BACKGROUND ART

Recently, the touch panel has become indispensable as an means of input for electronic devices. From comparatively large devices such as televisions, monitors, and whiteboards to comparatively small devices such as smartphones and tablets, the touch panel has come to be used generally as a means of input.

Additionally, there have been many proposals for touch panel systems equipped with a dedicated stylus pen able to provide not only information related to the touch position, but also additional information (for example, information such as the state of whether or not a button is being pressed, and pen pressure), enabling input with not only a finger but also the dedicated stylus pen, and thus enabling the realization of more precise and varied input.

For example, PTL 1 discloses a touch panel system enabling respective touch positions to be detected accurately, even when touch operations by multiple stylus pens or fingers are performed simultaneously.

The touch panel system of PTL 1 is equipped with multiple transmission electrodes (first signal lines) to which a drive signal and a pen synchronization signal are applied by a transmission unit, multiple reception electrodes (second signal lines) that output a response signal to a reception unit, and a stylus pen. The stylus pen sends out a pen identification signal to the reception electrodes in response to the detection of the pen synchronization signal on the transmission electrodes, and a control unit controls the drive timing at which the transmission unit applies the drive signal and the pen synchronization signal to the transmission electrodes, and additionally detects a touch position based on detection data output by the reception unit.

According to the above configuration, the drive timings of the stylus pen may be synchronized with the drive timings at which the control unit drives the transmission electrodes, and the indicating instrument that performed a touch operation may be determined based on the pen identification signal. As a result, touch operations performed with a finger and touch operations performed via a stylus pen may be detected at the same time.

### CITATION LIST

### Patent Literature

PTL 1: Japanese Unexamined Patent Application Publication No. 2012-22543 (Feb. 2, 2012)

### SUMMARY OF INVENTION

### Technical Problem

In the case of the touch panel system of PTL 1 above, it is necessary to synchronize the drive timings of the stylus pen with the drive timings at which the control unit drives the transmission electrodes. Furthermore, a method like the following is conceivable as a method of synchronizing the drive timings of the stylus pen with the drive timings at which the touch panel controller (control unit) drives the drive lines (transmission electrodes) of the touch panel.

FIG. 11 is a diagram for explaining a mechanism of notifying a device external to a touch panel controller, such as a stylus pen, of the drive timings of the touch panel controller.

FIG. 11 illustrates signal waveforms output from the touch panel controller to drive lines D₀ to Dₙ and a signal waveform corresponding to a drive line Dₙ₊₁ that drives the pen tip of a stylus pen.

On the stylus pen side, synchronization waveforms applied to the drive lines D₀ to Dₙ are received during a synchronization interval. The synchronization waveforms are detected by ascertaining changes in the high/low states of the received synchronization waveforms. Subsequently, the stylus pen uses the detected synchronization waveforms to set the drive timings at which to drive the pen tip of the stylus pen. Specifically, during a touch and pen input detection interval, drive signals are made to be output sequentially to the drive lines D₀ to Dₙ. For example, at the timing when the drive signal of the drive line Dₙ₋₁ goes from the high state to the low state, the drive signal of the next drive line Dₙ is made to go from the low state to the high state. Additionally, at the timing called Dₙ₊₁, by driving the pen tip of the stylus pen, for example, by changing the electrostatic capacitance of the touch panel, and detecting the change in the electrostatic capacitance via respective sense lines, the touch panel controller is able to detect additional information, such as the state of whether or not a button provided on the stylus pen is being pressed by the user, or the pen pressure.

However, depending on the position of the stylus pen with respect to the touch panel, the changes in the high/low states of the received synchronization waveforms may not be ascertained correctly, and in some cases, detecting the correct synchronization waveforms may be difficult.

FIG. 12 is a diagram illustrating synchronization waveforms received by the stylus pen depending on the position of the stylus pen with respect to the touch panel (the distance between the stylus pen and the sensor face of the touch panel).

FIG. 12(a) is a diagram illustrating the synchronization waveform received by a stylus pen 103 in the case in which the stylus pen 103 is distanced from a touch panel 102 by more than a suitable distance. As illustrated in the diagram, the synchronization waveform received by the stylus pen 103 has no amplitude, and changes in the high/low states cannot be ascertained. In such cases, the stylus pen 103 may fail to detect a synchronization signal.

FIG. 12(b) is a diagram illustrating the synchronization waveform received by the stylus pen 103 in the case in which the stylus pen 103 is the suitable distance away from the touch panel 102. As illustrated in the diagram, in such cases, changes in the high/low states are expressed comparatively clearly in the synchronization waveform received by the stylus pen 103, and the stylus pen 103 is able to detect a synchronization signal easily.

FIG. 12(c) is a diagram illustrating the synchronization waveform received by the stylus pen 103 in the case in which the stylus pen 103 is closer to the touch panel 102 than the suitable distance. As illustrated in the diagram, in such cases, the received signal level in the synchronization waveform received by the stylus pen 103 is too strong, the received synchronization waveform becomes crushed, changes in the high/low states may not be ascertained correctly, and the stylus pen 103 may fail to detect a synchronization signal.

The stylus pen may exist at any position with respect to the touch panel, but as discussed above, when the stylus pen is farther away from the touch panel than a suitable distance or closer to the touch panel than a suitable distance, there is a problem in that the stylus pen may not ascertain the synchronization waveform correctly, and may fail to detect a synchronization signal.

In addition, if the stylus pen fails to detect a synchronization signal, then in a device such as a stylus pen that includes a function of driving the pen tip at certain timings, for example, a problem occurs in which the timings at which to drive the pen tip cannot be set.

An objective of the present invention is to provide a touch panel controller, a touch panel system, and a stylus pen capable of minimizing the possibility of the stylus pen failing to detect a synchronization signal.

### Solution to Problem

To solve the above problem, a touch panel controller of the present invention is a touch panel controller that outputs, to a touch panel, a synchronization signal acquired by a stylus pen at a certain timing, characterized in that the touch panel controller generates a preparation signal including a high state and a low state that acts as a reference for adjusting a reception sensitivity of the synchronization signal in the stylus pen, and outputs the preparation signal to the touch panel earlier than the timing at which to output the synchronization signal to the touch panel.

According to the above configuration, the touch panel controller generates a preparation signal including a high state and a low state that acts as a reference for adjusting the reception sensitivity of the synchronization signal in the stylus pen, and outputs the preparation signal to the touch panel earlier than the timing at which to output the synchronization signal to the touch panel.

Consequently, the stylus pen is able to use the preparation signal including a high state and a low state that acts as a reference for adjusting the reception sensitivity of the synchronization signal output from the touch panel controller, and thus a touch panel controller capable of minimizing the possibility of the stylus pen failing to detect the synchronization signal may be realized.

To solve the above problem, a touch panel system of the present invention is a touch panel system provided with a stylus pen, a touch panel, and a touch panel controller that outputs, to the touch panel, a synchronization signal acquired by the stylus pen at a certain timing, characterized in that the touch panel controller generates a preparation signal including a high state and a low state, and outputs the preparation signal to the touch panel earlier than the timing at which to output the synchronization signal to the touch panel, and the stylus pen is equipped with a synchronization signal reception adjustment circuit that adjusts a reception sensitivity of the synchronization signal in the stylus pen during a reception interval of the preparation signal, based on the received preparation signal.

According to the above configuration, the touch panel controller generates a preparation signal including a high state and a low state, and outputs the preparation signal to the touch panel earlier than the timing at which to output the synchronization signal to the touch panel. Additionally, the stylus pen is equipped with a synchronization signal reception adjustment circuit that adjusts the reception sensitivity of the synchronization signal in the stylus pen during a reception interval of the preparation signal, based on the received preparation signal.

Consequently, the stylus pen is able to adjust the reception sensitivity of the synchronization signal in the stylus pen during the reception interval of the preparation signal based on the received preparation signal, and thus a touch panel system capable of minimizing the possibility of the stylus pen failing to detect the synchronization signal may be realized.

To solve the above problem, a stylus pen of the present invention is a stylus pen that acquires a synchronization signal of a touch panel at a certain timing, characterized by comprising a synchronization signal reception adjustment circuit that receives a preparation signal at a timing earlier than the synchronization signal, and adjusts a reception sensitivity of the synchronization signal during a reception interval of the preparation signal, based on the received preparation signal.

According to the above configuration, there is provided a synchronization signal reception adjustment circuit that receives a preparation signal at a timing earlier than the synchronization signal, and adjusts the reception sensitivity of the synchronization signal during a reception interval of the preparation signal, based on the received preparation signal.

Consequently, the stylus pen is able to adjust the reception sensitivity of the synchronization signal in the stylus pen during the reception interval of the preparation signal based on the received preparation signal, and thus a stylus pen capable of minimizing the possibility of failing to detect the synchronization signal may be realized.

### Advantageous Effects of Invention

According to an aspect of the present invention, a touch panel controller, a touch panel system, and a stylus pen capable of minimizing the possibility of the stylus pen failing to detect a synchronization signal may be realized.

### BRIEF DESCRIPTION OF DRAWINGS

FIG. 1 is a block diagram illustrating a schematic configuration of a touch panel system according to Embodiment 1.

FIG. 2 is a diagram illustrating a schematic circuit configuration of a touch panel provided in the touch panel system according to Embodiment 1.

FIG. 3 is a diagram illustrating signal waveforms output to a touch panel from a touch panel controller provided in the touch panel system according to Embodiment 1, and a signal waveform indicating a drive timing at which to drive a pen tip of a stylus pen.

FIG. 4 is a diagram illustrating preparation waveforms and synchronization waveforms received by a stylus pen depending on the position of the stylus pen with respect to a touch panel provided in the touch panel system according to Embodiment 1.

FIG. 5 is a diagram illustrating a schematic configuration of a touch panel controller provided in the touch panel system according to Embodiment 1.

FIG. 6 is a cross-section diagram illustrating a configuration of a stylus pen provided in the touch panel system according to Embodiment 1.

FIG. 7 is a diagram for explaining the timings at which a synchronization signal detection circuit of a stylus pen acquires a synchronization signal.

FIG. 8 is a diagram illustrating an example of the waveform of a preparation signal used by a touch panel system according to Embodiment 2.

FIG. 9 is a diagram illustrating an example of the waveform of a preparation signal used by a touch panel system according to Embodiment 3.

FIG. 10 is a function block diagram illustrating a configuration of a mobile phone according to Embodiment 4.

FIG. 11 is a diagram for explaining a mechanism of notifying a device external to a touch panel controller, such as a stylus pen, of the drive timings of the touch panel controller.

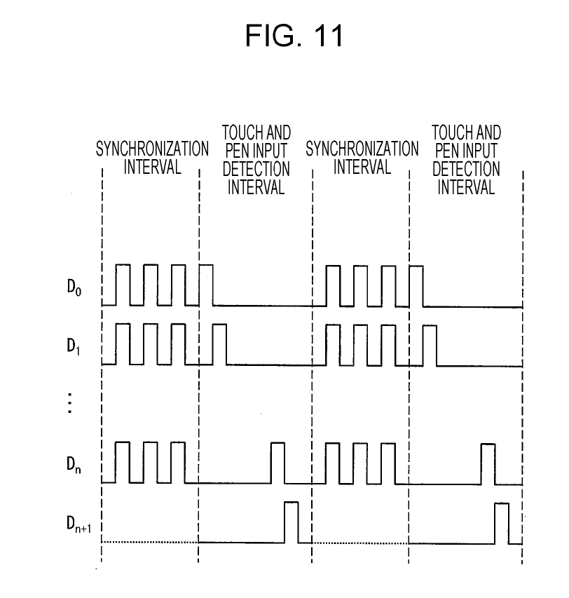

FIG. 12 is a diagram illustrating synchronization waveforms received by a stylus pen depending on the position of the stylus pen with respect to a touch panel in a touch panel system of the related art.

### DESCRIPTION OF EMBODIMENTS

Hereinafter, embodiments of the present invention will be described in detail on the basis of the drawings. However, features such as the dimensions, materials, shapes, and relative arrangement of the components described in the embodiments are merely a possible embodiment, and the interpretation of the claims should not be restricted thereby.

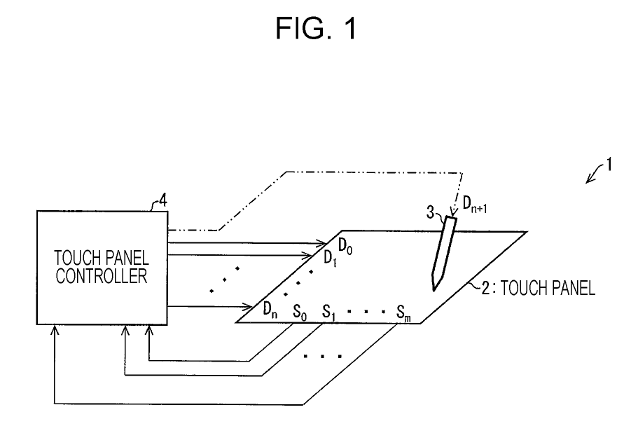

Embodiments of the present invention are described as follows on the basis of FIGS. 1 to 10.

### Embodiment 1

An embodiment of the present invention is described as follows on the basis of FIGS. 1 to 6.

### (Touch Panel System)

FIG. 1 is a block diagram illustrating a schematic configuration of a touch panel system 1 according to the present embodiment.

As illustrated in the drawing, the touch panel system 1 is equipped with a touch panel 2, a stylus pen 3, and a touch panel controller 4 that drives the touch panel 2 and the stylus pen 3.

### (Touch Panel)

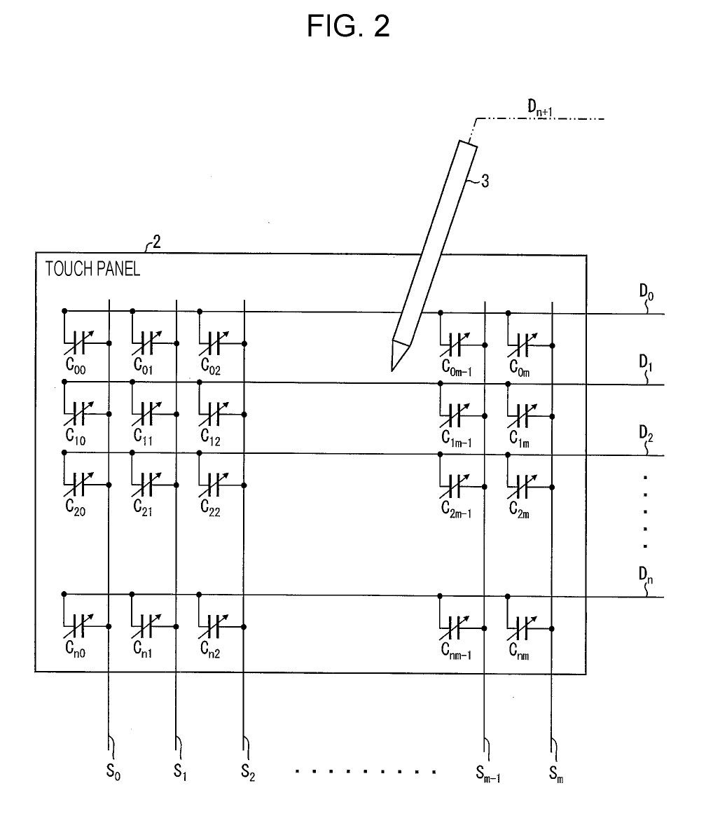

FIG. 2 is a diagram illustrating a diagrammatic circuit configuration of the touch panel 2 provided in the touch panel system 1.

As illustrated in the drawing, multiple (a number n of) drive lines D₀ to Dₙ (first signal lines) extending parallel in the left-and-right direction of the drawing are provided, and multiple (a number m of) sense lines S₀ to Sₘ (second signal lines) extending parallel in the up-and-down direction of the drawing are provided so as to intersect with the drive lines D₀ to Dₙ. Additionally, at the locations where each of the above drive lines D₀ to Dₙ intersects each of the above sense lines S₀ to Sₘ, capacitors C₀₀ to Cₙₘ for accumulating electrostatic capacitance are provided. Note that m and n above may be the same or different from each other.

Furthermore, during a touch and pen input detection interval to be discussed in detail later, the touch panel controller 4 drives each of the drive lines D₀ to Dₙ while also detecting, via each of the sense lines S₀ to Sₘ, changes in the electrostatic capacitance due to touch, and thereby detects the touch position.

Note that although the present embodiment is described by taking a capacitive touch panel as an example, the touch panel is not limited thereto, insofar as the touch panel is of a type in which the stylus pen receives a synchronization signal output from the touch panel controller to the touch panel, the stylus pen acquires the synchronization signal at a certain timing, and synchronization between the touch panel controller and the stylus pen is conducted. For example, a resistive touch panel or the like may also be used.

(Signal Waveforms Output from Touch Panel Controller to Touch Panel)

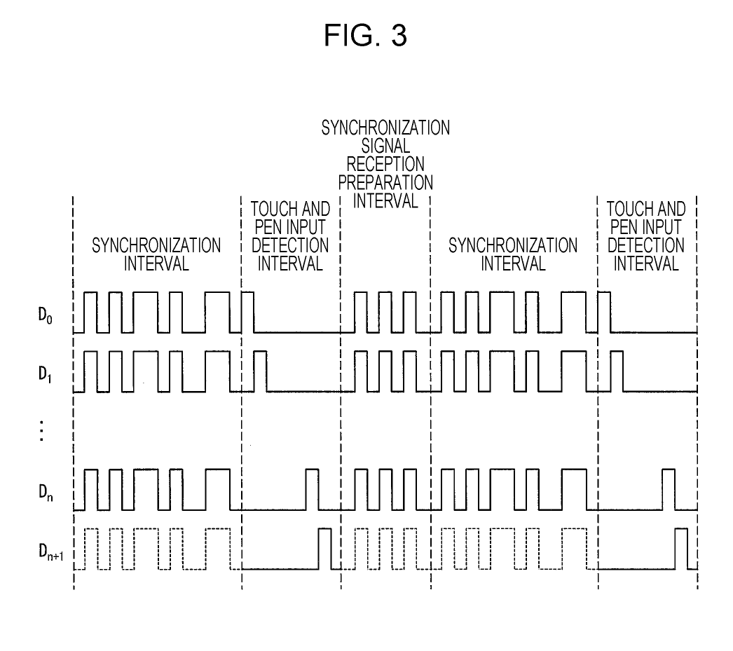

FIG. 3 is a diagram illustrating signal waveforms output from a touch panel controller to a touch panel, and a signal waveform indicating a drive timing at which to drive a pen tip of a stylus pen.

As illustrated in the drawing, during the synchronization interval, the same synchronization signal is output from the touch panel controller 4 (see FIG. 1) to the drive lines D₀ to Dₙ of the touch panel 2 (see FIG. 1), whereas during the touch and pen input detection interval, a drive signal is output sequentially to the drive lines D₀ to Dₙ.

In other words, during the touch and pen input detection interval, at the timing when the drive signal of the drive line Dₙ₋₁ goes from high to low, the drive signal of the next drive line Dₙ goes from low to high.

Additionally, the stylus pen 3 receives a synchronization signal from the touch panel 2, acquires the synchronization signal at a certain timing, conducts synchronization, and at the timing when the drive signal goes from high to low during the touch and pen input detection interval of the drive line Dₙ illustrated in the drawing, or in other words, at the timing when the drive signal goes from low to high during the touch and pen input detection interval of the virtual drive line Dₙ₊₁, the pen tip of the stylus pen 3 is driven, the electrostatic capacitance on the touchscreen of the touch panel 2 is changed, and the change in the electrostatic capacitance is detected via each of the sense lines S₀ to Sₘ, thereby enabling the touch panel controller 4 to detect additional information, such as the state of whether or not a button provided on the stylus pen 3 is being pressed by the user, or the pen pressure.

Note that the drive line Dₙ₊₁ is designated a virtual drive line because, unlike the drive lines D₀ to Dₙ, the drive line Dₙ₊₁ is not provided in the touch panel 2, but instead is a drive line that is adopted virtually to explain how the stylus pen 3 that wireless transmits and receives signal to and from the touch panel controller 4 receives a synchronization signal, and based on this synchronization signal, decides the timing at which to drive the pen tip of the stylus pen 3.

Consequently, in the signal waveform of the virtual drive line Dₙ₊₁ illustrated in FIG. 3, the preparation waveform (discussed later) during the synchronization signal reception preparation interval and the synchronization waveform during the synchronization interval, indicated by the dashed lines, are waveforms that the stylus pen 3 receives from the touch panel 2, while the drive waveform during the touch and pen input detection interval indicates the timing at which the pen tip of the stylus pen 3 is driven. On the other hand, the signal waveforms of the drive lines D₀ to Dₙ illustrated in FIG. 3 are the signals applied to the drive lines D₀ to Dₙ of the touch panel 2 by the touch panel controller 4. Also, although not illustrated, the sense lines S₀ to Sₘ are driven to match the drive timings of the drive lines D₀ to Dₙ during the touch and pen input detection interval as well as the pen tip drive timings of the virtual drive line Dₙ₊₁ during the touch and pen input detection interval.

Furthermore, in the present embodiment, as illustrated in the drawing, a synchronization signal reception preparation interval is provided at a timing earlier than the synchronization interval. During the synchronization signal reception preparation interval, an identical preparation signal (preparation waveform) is applied to the drive lines D₀ to Dₙ of the touch panel 2 by the touch panel controller 4.

As illustrated in the drawing, during the synchronization signal reception preparation interval, before a synchronization signal is output to the drive lines D₀ to Dₙ of the touch panel 2 by the touch panel controller 4, the touch panel controller 4 outputs a preparation signal including a high state and a low state that acts as a reference for adjusting the reception sensitivity of the synchronization signal in the stylus pen 3, and as discussed later in detail, detection of the synchronization signal by the stylus pen 3 becomes easier.

Note that in the present embodiment, a case is described in which Dₙ₊₁ denotes the virtual drive line indicating the timing at which the pen tip of the stylus pen 3 is driven, while the drive lines D₀ to Dₙ are provided in the touch panel 2. However, the virtual drive line indicating the timing at which the pen tip of the stylus pen 3 is driven does not necessarily need to be Dₙ₊₁, and may also be a drive line such as D₀ or Dₙ₊₂. For example, if drive lines D₁ to Dₙ₊₁ are taken to be provided in the touch panel 2, D₀ or a drive line on or after Dₙ₊₂ may be treated as the virtual drive line, and the pen tip may be driven with that waveform.

Additionally, in the present embodiment, as illustrated in the drawing, the case of sequential driving is described for the driving of the drive lines D₀ to Dₙ and the virtual drive line Dₙ₊₁. However, an m-sequence, Hadamard code, or the like may also be used as a code sequence to implement parallel driving for the for the driving of the drive lines D₀ to Dₙ and the virtual drive line Dₙ₊₁. In the case of using parallel driving, the position of an object of detection may be detected from a correlation value computed by performing a correlation operation on the code sequence, or the position of an object of detection may be detected from a reconstructed value computed by performing a reconstruction operation on the code sequence.

In the case of implementing parallel driving of the drive lines D₀ to Dₙ and the virtual drive line Dₙ₊₁, the sensing count (number of integrations) may be increased, and thus the S/N ratio may be improved, and highly precise position detection may be conducted.

Note that although the present embodiment is described by taking, as an example, a case in which the preparation signal and the synchronization signal are output to all of the drive lines D₀ to Dₙ, the configuration is not limited thereto. The present invention is also applicable to a case in which the preparation signal and the synchronization signal are output only to a subset of the drive lines D₀ to Dₙ.

Note that the voltage levels of the preparation signal and the synchronization signal may be adjusted appropriately in consideration of factors such as the number of drive lines to output to.

### (Signal Waveforms Received by Stylus Pen)

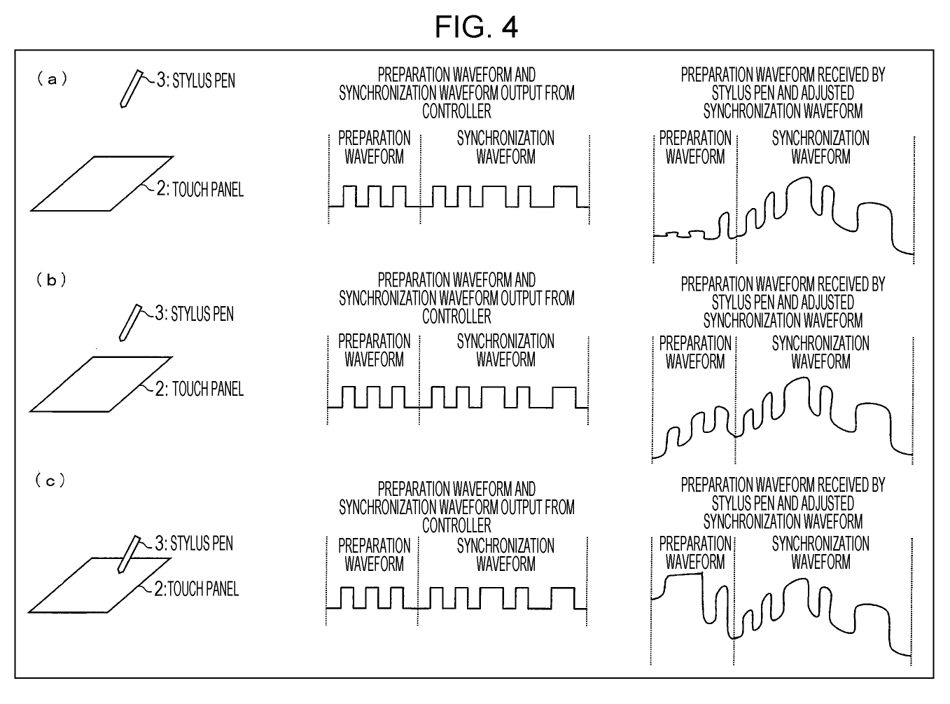

FIG. 4 is a diagram illustrating preparation waveforms and synchronization waveforms received by the stylus pen 3 depending on the position of the stylus pen 3 with respect to the touch panel 2 (the distance between the stylus pen 3 and the sensor face of the touch panel 2).

FIG. 4(a) is a diagram illustrating the preparation waveform and the synchronization waveform received by the stylus pen 3 in the case in which the stylus pen 3 is distanced from the touch panel 2 by more than a suitable distance.

As discussed earlier, before a synchronization signal is output to the drive lines D₀ to Dₙ of the touch panel 2 by the touch panel controller 4, the touch panel controller 4 outputs a preparation signal including a high state and a low state that acts as a reference for adjusting the reception sensitivity of the synchronization signal in the stylus pen 3.

Additionally, although discussed later in detail, the stylus pen 3 is equipped with a synchronization signal reception adjustment circuit that receives the preparation signal, and adjusts the reception sensitivity of the synchronization signal, based on the received preparation signal.

Consequently, in the synchronization signal reception adjustment circuit of the stylus pen 3, if the amplitude of the preparation signal received by the stylus pen 3 is determined to be small, as in FIG. 4(a), the gain is raised to increase the amplitude during the synchronization signal reception preparation interval illustrated in FIG. 3. Thus, in the synchronization signal that the stylus pen 3 receives after receiving the preparation signal, changes in the high/low states are expressed comparatively clearly, enabling the stylus pen 3 to detect the synchronization signal consistently.

FIG. 4(b) is a diagram illustrating the preparation waveform and the synchronization waveform received by the stylus pen 3 in the case in which the stylus pen 3 is a suitable distance away from the touch panel 2.

In this case, in the preparation signal received by the stylus pen 3, changes in the high/low states are expressed comparatively clearly. Consequently, in the synchronization signal reception adjustment circuit of the stylus pen 3, it is not necessary to tune to a suitable amplitude by raising or lowering the gain, and in the synchronization signal that the stylus pen 3 receives after receiving the preparation signal, changes in the high/low states are expressed comparatively clearly, enabling the stylus pen 3 to detect the synchronization signal consistently.

FIG. 4(c) is a diagram illustrating the preparation waveform and the synchronization waveform received by the stylus pen 3 in the case in which the stylus pen 3 is closer to the touch panel 2 than a suitable distance.

As illustrated in the diagram, in such cases, the received signal level of the preparation signal received by the stylus pen 3 is too strong, the received preparation waveform becomes crushed, and changes in the high/low states may not be ascertained correctly.

Consequently, in the synchronization signal reception adjustment circuit of the stylus pen 3, if the amplitude of the preparation signal received by the stylus pen 3 is determined to be large, as in FIG. 4(c), the gain is lowered to tune to a suitable amplitude during the synchronization signal reception preparation interval illustrated in FIG. 3. Thus, in the synchronization signal that the stylus pen 3 receives after receiving the preparation signal, changes in the high/low states are expressed comparatively clearly, enabling the stylus pen 3 to detect the synchronization signal consistently.

Note that in the present embodiment, as illustrated in FIG. 4, the adjustment of the reception sensitivity of the synchronization signal is conducted at a timing at the end of the synchronization signal reception preparation interval (see FIG. 3), or in other words, immediately before receiving the synchronization signal. However, the configuration is not limited thereto, and it is sufficient to conduct the adjustment of the reception sensitivity of the synchronization signal during the synchronization signal reception preparation interval.

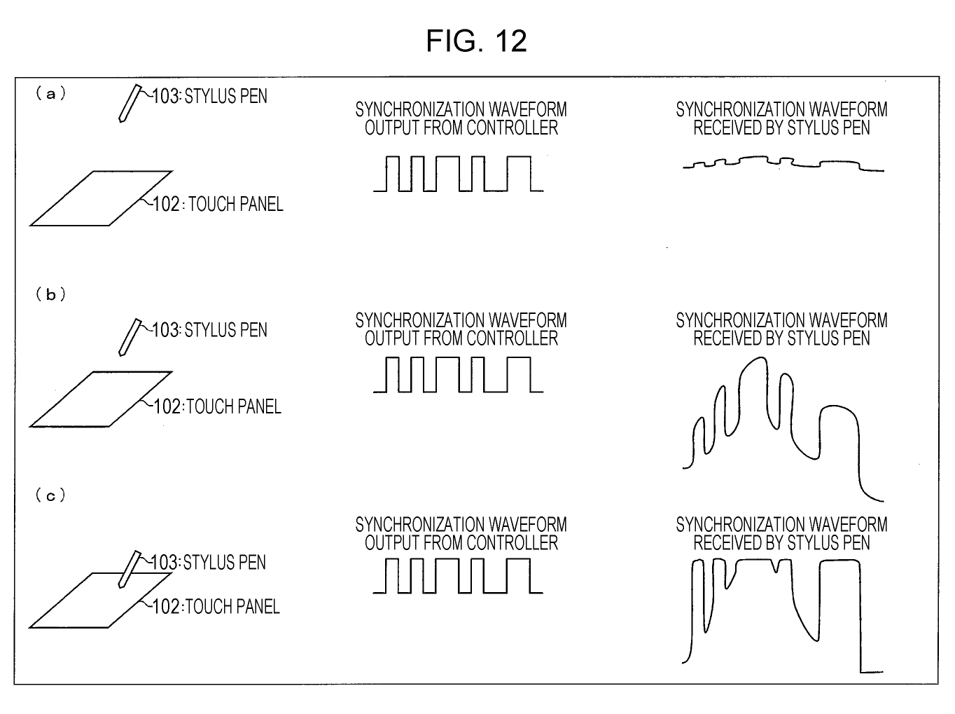

On the other hand, in the related art, since such a preparation signal does not exist, the operation of raising or lowering the gain to tune to a suitable amplitude is conducted immediately after a synchronization signal is acquired by the stylus pen 3, and thus there is a problem in that part of the synchronization waveform is not acquired correctly (see FIG. 12).

### (Touch Panel Controller)

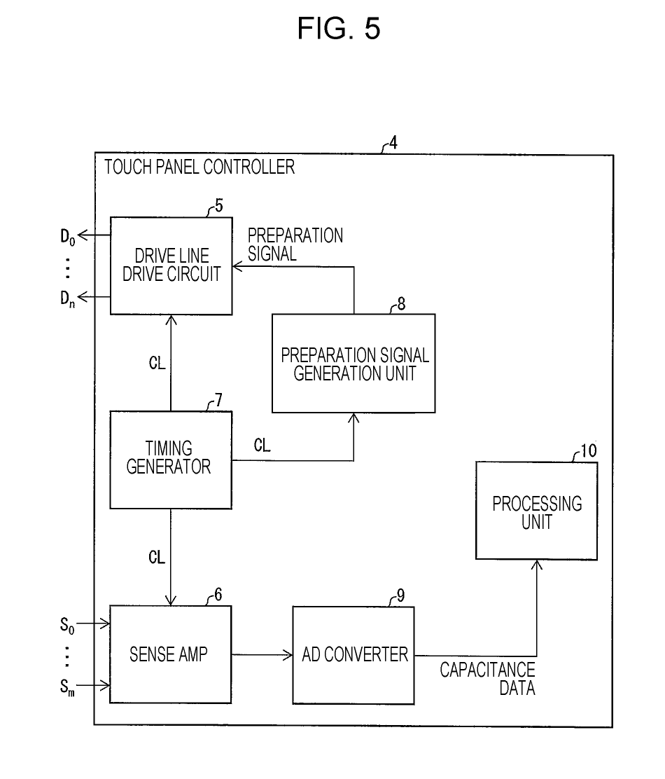

FIG. 5 is a diagram illustrating a schematic configuration of the touch panel controller 4 provided in the touch panel system 1.

As illustrated in the drawing, the touch panel controller 4 is equipped with a drive line driving circuit 5, a sense amplifier 6, a timing generator 7, a preparation signal generation unit 8, an AD converter 9, and a processing unit 10.

The drive line driving circuit 5 is a circuit that outputs a synchronization signal and a drive signal generated on the basis of a clock signal CL generated by the timing generator 7 to each of the drive lines D₀ to Dₙ.

The sense amplifier 6 is a circuit that acquires capacitance data via each of the sense lines S₀ to Sₘ based on the clock signal CL generated by the timing generator 7, the above drive signal, and a drive signal of the pen tip of the stylus pen 3, and sends the acquired capacitance data to the AD converter 9.

In the timing generator 7, the clock signal CL is generated and sent to components such as the drive line driving circuit 5, the sense amplifier 6, and the preparation signal generation unit 8.

The preparation signal generation unit 8 generates a preparation signal based on the clock signal CL from the timing generator 7, and controls the drive line driving circuit 5 to output the preparation signal to each of the drive lines D₀ to Dₙ before the synchronization signal is output to each of the drive lines D₀ to Dₙ.

Note that the present embodiment describes a configuration equipped with the preparation signal generation unit 8 to enable the generation of one preparation signal selected from among a variety of types of preparation signals, including the preparation signals described in Embodiments 2 and 3 discussed later, for example. However, the preparation signal may also be generated by the timing generator 7.

Preferably, the preparation signal is output every time a synchronization signal is output, at a timing before the synchronization signal is output. In so doing, it is possible to minimize the possibility of the stylus pen 3 failing to detect the synchronization signal, even if the stylus pen 3 is moved suddenly by a large amount.

Note that the AD converter 9 is configured to convert the capacitance data into digital data, and then send the digital data to the processing unit 10.

Additionally, the processing unit 10 is configured to detect, from the capacitance data, information related to the touch position, and additional information such as whether or not a button provided on the stylus pen 3 is being pressed by the user, and the pen pressure.

Also, in the processing unit 10, processing corresponding to a determined input operation is performed on the basis of the capacitance data related to the touch position and the additional information.

### (Stylus Pen)

The stylus pen 3 according to the present embodiment includes a pen pressure sensor for sensing the pen pressure, for example, and a pen pressure signal from the pen pressure sensor is output while synchronizing with the touch panel controller 4. However, the stylus pen 3 is not necessarily limited thereto, and may also not include the pen pressure sensor for sensing the pen pressure.

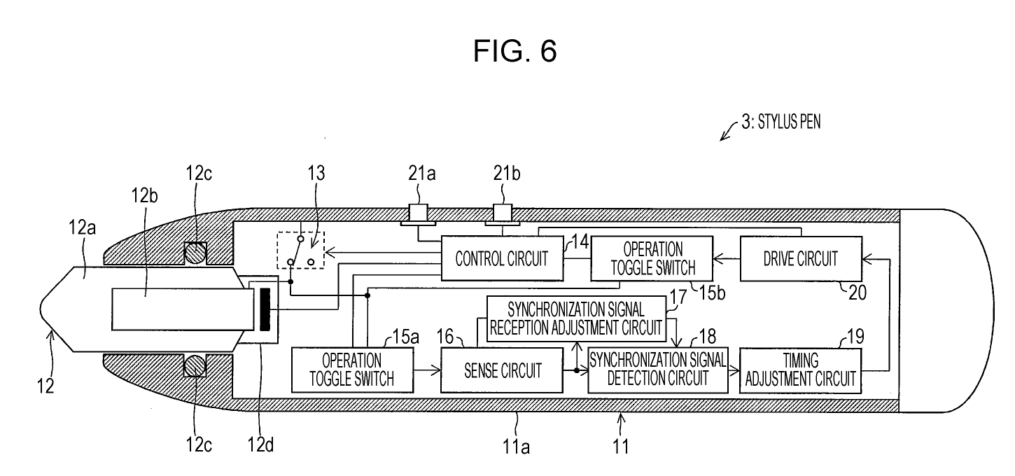

FIG. 6 is a cross-section diagram illustrating a configuration of the stylus pen 3.

As illustrated in FIG. 6, the stylus pen 3 includes a pen body 11, gripped by the user's hand, that includes a conductive grip portion 11a formed in an approximately cylindrical shape for being gripped by the user's hand. At the leading end of the pen body 11, there is provided a pen tip portion 12 that is pressed against the touch panel 2 during touch operations.

The pen tip portion 12 includes a pen tip cover 12a, a pen tip shaft 12b, insulators 12c and 12c that movably hold the pen tip cover 12a to allow advancing in the shaft direction, and a pen pressure sensor 12d provided on the interior side of the pen tip shaft 12b.

The pen tip cover 12a is made of an insulating material, while the pen tip shaft 12b is made of a conductive material, such as metal or a conductive polymer material, for example.

In addition, the pen pressure sensor 12d is made of a semiconductor piezoresistive pressure sensor, for example, in which a semiconductor strain gauge is formed on the surface of a diaphragm (not illustrated). Consequently, if the pen tip cover 12a of the pen tip portion 12 is pressed against the touch panel 2 during a touch operation, the pen tip shaft 12b is pushed inward via the pen tip cover 12a to press on the surface of the diaphragm of the pen pressure sensor 12d, and the resulting change in electrical resistance due to the piezoresistive effect produced by the deformation of the diaphragm is converted into an electrical signal. Consequently, the pen pressure of the stylus pen 3 may be detected. Furthermore, the basic principle of pen pressure detection is not necessarily limited to the above, and another detection principle may also be implemented.

Note that inside the pen body 11, a connection switch 13, a control circuit 14, operation toggle switches 15a and 15b, a sense circuit 16, a synchronization signal reception adjustment circuit 17, a synchronization signal detection circuit 18, a timing adjustment circuit 19, and a drive circuit 20 are provided.

The connection switch 13 includes a grip portion terminal connected to the grip portion 11a, a pen tip terminal connected to the pen tip shaft 12b, and a ground terminal having a ground potential. The connection switch 13 switches the connection with the grip portion terminal to one of either the pen tip terminal or the ground terminal.

Furthermore, it is also possible to omit the connection switch 13. In the case of omitting the connection switch 13, the grip portion 11a of the pen body 11 is connected to a reference potential (GND), for example.

The connection switch 13 is an electronic switch made up of a field-effect transistor (FET) or the like, and is controlled on and off by the control circuit 14. Herein, when the connection switch 13 is off, the pen tip shaft 12b is electrically cut off from the grip portion 11a of the pen body 11. At this time, since the capacitance between the pen tip portion 12 and the touch panel 2 is small, the stylus pen 3 may have difficulty acquiring the synchronization signal of the touch panel 2, even if the pen tip cover 12a is brought into close proximity with the touch panel 2.

On the other hand, when the connection switch 13 turns on, the pen tip shaft 12b is electrically connected to the grip portion 11a of the pen body 11, and the human body makes an electrical connection with the pen tip shaft 12b via the grip portion 11a. Consequently, since the human body has a comparatively large electrostatic capacitance, when the stylus pen 3 comes into proximity with or contacts the touch panel 2, the stylus pen 3 is able to acquire the synchronization signal of the touch panel easily.

Additionally, the stylus pen 3 is provided with a first operating switch 21a and a second operating switch 21b of the push type, for example. By pushing the first operating switch 21a and the second operating switch 21b, a function assigned to each of the first operating switch 21a and the second operating switch 21b is made to be executed via the control circuit 14. The function assigned to the first operating switch 21a may be an eraser function, for example, enabling the eraser function to be turned on and off with the first operating switch 21a. Also, the function assigned to the second operating switch 21b may be a mouse right-click function, for example, enabling the mouse right-click function to be turned on and off with the second operating switch 21b.

Furthermore, the eraser function and the mouse right-click function are examples, and the assigned functions are not limited to the eraser function and the mouse right-click function. Also, other additional operating switches may be provided to enable the addition of other functions.

Note that the touch position of the stylus pen 3 on the touch panel 2 is detected as a result of touching the stylus pen 3 to the touch panel 2 while the connection switch 13 of the stylus pen 3 is turned off (the state in which the pen tip shaft 12b is electrically isolated from the grip portion 11a of the pen body 11). Additionally, the touch position is detected by driving the virtual drive line Dₙ₊₁ or the like.

Furthermore, in the present embodiment, in order for the touch panel controller 4 to detect the driving of the pen tip portion 12 in the stylus pen 3, the pen tip of the stylus pen 3 is driven by varying a waveform corresponding to the virtual drive line Dₙ₊₁ or the like to change the electrostatic capacitance on the touchscreen of the touch panel 2, and by detecting the change in the electrostatic capacitance via each of the sense lines S₀ to Sₘ, the touch panel controller 4 is able to detect additional information, such as the state of whether or not a button provided on the stylus pen 3 is being pressed by the user, or the pen pressure.

Meanwhile, the stylus pen 3 according to the present embodiment wirelessly transmits and receives signals to and from the touch panel controller 4. Consequently, the pen tip 12 is driven with the same pattern as that which drives the virtual drive line Dₙ₊₁, so as to be compatible with the drive timings of the drive lines D₀ to Dₙ in the touch panel controller 4. Accordingly, in the stylus pen 3, the drive circuit 20 is provided to perform driving similarly to the driver of the touch panel controller 4.

The driving of the drive lines D₀ to Dₙ in the touch panel controller 4 is based on drive timings generated by the timing generator 7 (FIG. 5). For this reason, the stylus pen 3 must also be made to operate in synchronization with the timings driven by the touch panel controller 4. Accordingly, in the stylus pen 3 according to the present embodiment, by providing the sense circuit 16, the synchronization signal reception adjustment circuit 17, the synchronization signal detection circuit 18, and the timing adjustment circuit 19, it is possible to minimize the possibility of the stylus pen 3 failing to detect a synchronization signal driven by the touch panel controller 4, and in addition, align the timing of the synchronization signal of the touch panel controller 4 with the timing of a pen synchronization signal produced by the timing adjustment circuit 19 in the stylus pen 3.

The stylus pen 3 uses the sense circuit 16, the synchronization signal reception adjustment circuit 17, and the synchronization signal detection circuit 18 to detect the synchronization signal produced by the timing generator 7 (FIG. 5) of the touch panel controller 4.

Note that the driving operation of the stylus pen 3 is made up of the repetition of three intervals: a preparation signal and synchronization signal detection interval in which the operation toggle switch 15a is turned on, the operation toggle switch 15b is turned off, and the preparation signal and the synchronization signal from the touch panel controller 4 are detected by the sense circuit 16, the synchronization signal reception adjustment circuit 17, and the synchronization signal detection circuit 18; a preparation interval; and a drive mode interval in which the operation toggle switch 15a is turned off, the operation toggle switch 15b is turned on, and the pen tip portion 12 is driven by the drive circuit 20.

Note that when the operation toggle switch 15a is turned on and the operation toggle switch 15b is turned off, the pen tip terminal and the grip portion terminal in the connection switch 13 are connected. On the other hand, when the operation toggle switch 15b is turned on and the operation toggle switch 15a is turned off, the ground terminal and the grip portion terminal in the connection switch 13 are connected.

The synchronization signal reception adjustment circuit 17 adjusts the gain settings of the sense circuit 16 and the acquisition timing of the synchronization signal detection circuit 18, based on the output of the preparation signal from the sense circuit 16.

In other words, if the output of the preparation signal from the sense circuit 16 is determined to be small, the synchronization signal reception adjustment circuit 17 raises the gain of the sense circuit 16 to increase the amplitude during the synchronization signal reception preparation interval illustrated in FIG. 3. Thus, in the synchronization signal that the sense circuit 16 receives after receiving the preparation signal, changes in the high/low states are expressed comparatively clearly, enabling the stylus pen 3 to detect the synchronization signal consistently. On the other hand, if the output of the preparation signal from the sense circuit 16 is determined to be too large, the synchronization signal reception adjustment circuit 17 lowers the gain of the sense circuit 16 to tune to a suitable amplitude during the synchronization signal reception preparation interval illustrated in FIG. 3. Thus, in the synchronization signal that the sense circuit 16 receives after receiving the preparation signal, changes in the high/low states are expressed comparatively clearly, enabling the stylus pen 3 to detect the synchronization signal consistently.

The preparation signal and synchronization signal detection interval in the stylus pen 3 is a standby interval that first detects the preparation signal, and then based on the preparation waveform, detects a bit pattern expressing a synchronization waveform with adjusted reception sensitivity, and is an interval that cuts the drive of the pen tip portion 12, and detects the synchronization signal pattern from the pen tip signal waveform.

Additionally, the preparation interval in the stylus pen 3 is a preparation interval for starting to drive the pen tip at timings in alignment with the touch panel controller 4 after the synchronization signal pattern is detected, and is an interval that interprets additional information that takes timings at the start of driving.

In addition, the drive mode interval in the stylus pen 3 is an interval that drives the pen tip portion 12 with the drive circuit 20, and is an interval that drives the pen tip portion 12 in alignment with the drive timings of the touch panel controller 4, while also making fine adjustments to the edges of the drive waveform. At this point, the drive circuit 20 of the stylus pen 3 is driven in alignment with the drive timings of the touch panel controller 4. The drive circuit 20 turns on the operation toggle switch 15b while also turning off the operation toggle switch 15a, and drives the pen tip portion 12 via the control circuit 14.

Note that in the present embodiment, a case is described in which the synchronization signal reception adjustment circuit 17 configures the gain settings of the sense circuit 16 based on the output of the preparation signal from the sense circuit 16. However, in Embodiments 2 and 3, a case will be described in which the synchronization signal reception adjustment circuit 17 adjusts the acquisition timing of the synchronization signal detection circuit 18 and the like based on the output of the preparation signal from the sense circuit 16.

Note that in the touch panel system 1 of the present embodiment, a case is described in which the function of the drive lines D₀ to Dₙ (first signal lines) and the function of the sense lines S₀ to Sₘ (second signal lines) are respectively fixed. However, a configuration that detects the touch position by alternating between the drive lines D₀ to Dₙ and the sense lines S₀ to Sₘ on a fixed cycle is also acceptable.

### Embodiment 2

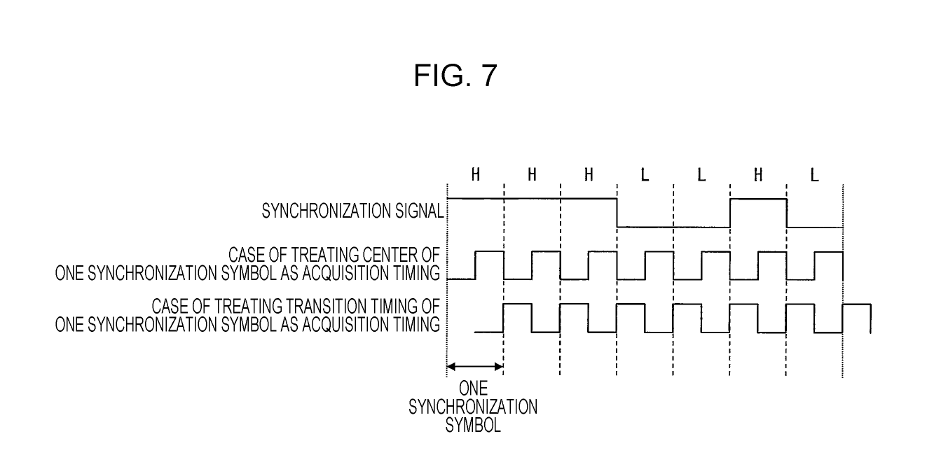

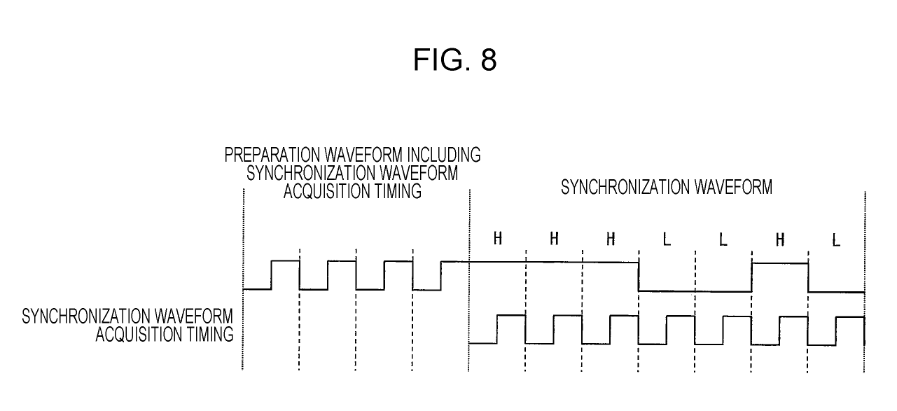

Next, Embodiment 2 of the present invention will be described on the basis of FIGS. 7 and 8. The present embodiment differs from Embodiment 1 above in that the preparation signal generated by the preparation signal generation unit 8 of the touch panel controller 4 (see FIG. 5) is a signal determining the timing at which the synchronization signal detection circuit 18 of the stylus pen 3 (see FIG. 6) acquires a synchronization signal. Otherwise, the configuration is as described in Embodiment 1. For the sake of convenience, members having the same function as the members illustrated in the drawings of the above Embodiment 1 are given the same signs, and description thereof will be reduced or omitted.

FIG. 7 is a diagram for explaining the timings at which the synchronization signal detection circuit 18 of the stylus pen 3 acquires a synchronization signal.

The synchronization signal detection circuit 18 samples the synchronization waveform on a fixed cycle, and when acquiring one synchronization symbol (a unit signal constituting the synchronization signal) labeled H or L in the drawing, it is desirable to sample at the center of each synchronization symbol, like in the case in which the acquisition timing is at the center of one synchronization symbol as illustrated in the drawing.

However, since the synchronization signal detection circuit 18 of the stylus pen 3 is unable to know the acquisition timing, in the case in which the acquisition timing is at the timing when one synchronization symbol changes as illustrated in the drawing, when sampling is performed at the point where the data changes, there is a risk of detection failure, since the signal state is neither H nor L consistently.

Accordingly, in the present embodiment, a signal determining the timing at which the synchronization signal detection circuit 18 of the stylus pen 3 acquires the a synchronization signal is used as the preparation signal generated by the preparation signal generation unit 8 of the touch panel controller 4.

FIG. 8 is a diagram illustrating an example of the waveform of the preparation signal used in the present embodiment.

As illustrated in the drawing, the preparation signal used in the present embodiment is a signal determining the timing at which the synchronization signal detection circuit 18 of the stylus pen 3 (see FIG. 6) acquires the synchronization signal, and is a signal that sets the acquisition timing to the center (the center in terms of timing) of one synchronization symbol of the synchronization signal (a unit signal constituting the synchronization signal).

First, the sense circuit 16 of the stylus pen 3 (see FIG. 6) receives such a preparation signal, and as already described in Embodiment 1, the synchronization signal reception adjustment circuit 17 configures the gain settings of the sense circuit 16 based on the output of the preparation signal from the sense circuit 16. Additionally, at the same time, the synchronization signal reception adjustment circuit 17 also adjusts the acquisition timing of the synchronization signal detection circuit 18 based on the output of the preparation signal from the sense circuit 16.

Consequently, in the synchronization signal detection circuit 18 of the stylus pen 3, a suitable acquisition timing is generated based on the received preparation waveform, and consistent detection of the synchronization signal may be performed.

Note that in some cases, the preparation signal received by the stylus pen 3 cannot be used to adjust the acquisition timing of the synchronization signal detection circuit 18 before configuring the gain settings of the sense circuit 16 of the stylus pen 3 based on the output from the preparation signal. However, in the stylus pen 3 of the present embodiment, since the gain settings of the sense circuit 16 of the stylus pen 3 are configured based on the output of the preparation signal partway through the preparation signal reception interval (at a timing that still leaves at least one high state or low state in the preparation waveform illustrated in FIG. 8), and thus the preparation signal received by the stylus pen 3 after the gain settings of the sense circuit 16 are configured may be used to adjust the acquisition timing of the synchronization signal detection circuit 18.

### Embodiment 3

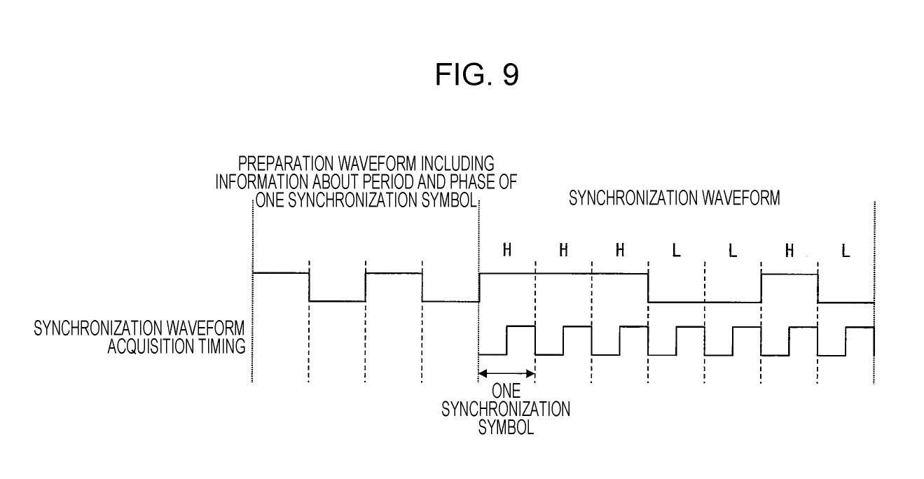

Next, Embodiment 3 of the present invention will be described based on FIG. 9. The present embodiment differs from Embodiments 1 and 2 above in that the preparation signal generated by the preparation signal generation unit 8 of the touch panel controller 4 (see FIG. 5) is a signal that includes information about the period of one synchronization symbol of the synchronization signal (a unit signal constituting the synchronization signal) and the phase of the synchronization signal. Otherwise, the configuration is as described in Embodiment 1. For the sake of convenience, members having the same function as the members illustrated in the drawings of the above Embodiment 1 are given the same signs, and description thereof will be reduced or omitted.

FIG. 9 is a diagram illustrating an example of the waveform of the preparation signal used in the present embodiment.

As illustrated in the drawing, the preparation signal used in the present embodiment is a signal that includes information about the period of one synchronization symbol of the synchronization signal (a unit signal constituting the synchronization signal) and the phase of the synchronization signal.

First, the sense circuit 16 of the stylus pen 3 (see FIG. 6) receives such a preparation signal, and as already described in Embodiment 1, the synchronization signal reception adjustment circuit 17 configures the gain settings of the sense circuit 16 based on the output of the preparation signal from the sense circuit 16. Additionally, at the same time, the synchronization signal reception adjustment circuit 17 also adjusts the acquisition timing of the synchronization signal detection circuit 18 based on the output of the preparation signal from the sense circuit 16.

When the stylus pen 3 receives a preparation signal including the period of one synchronization symbol of the synchronization signal (a unit signal constituting the synchronization signal), this preparation signal may be used to configure the synchronization signal detection circuit 18 to acquire the synchronization signal at the center (the center in terms of timing) of one synchronization symbol of the synchronization signal (a unit signal constituting the synchronization signal).

In addition, when the stylus pen 3 receives a preparation signal that includes information about the phase of the synchronization signal, this preparation signal may be used as a reference for determining H or L when the synchronization signal detection circuit 18 acquires and detects the synchronization signal at a certain timing.

Consequently, in the synchronization signal detection circuit 18 of the stylus pen 3, a suitable acquisition timing may be generated based on the received preparation waveform, and the determination of H or L may be conducted more precisely, thereby enabling consistent detection of the synchronization signal.

Note that in some cases, the preparation signal received by the stylus pen 3 cannot be used to adjust the acquisition timing of the synchronization signal detection circuit 18 and determine H or L before configuring the gain settings of the sense circuit 16 of the stylus pen 3 based on the output from the preparation signal. However, in the stylus pen 3 of the present embodiment, since the gain settings of the sense circuit 16 of the stylus pen 3 are configured based on the output of the preparation signal partway through the preparation signal reception interval (at a timing that still leaves at least one high state or low state in the preparation waveform illustrated in FIG. 9), and thus the preparation signal received by the stylus pen 3 after the gain settings of the sense circuit 16 are configured may be used to adjust the acquisition timing of the synchronization signal detection circuit 18 and determine H or L.

### Embodiment 4

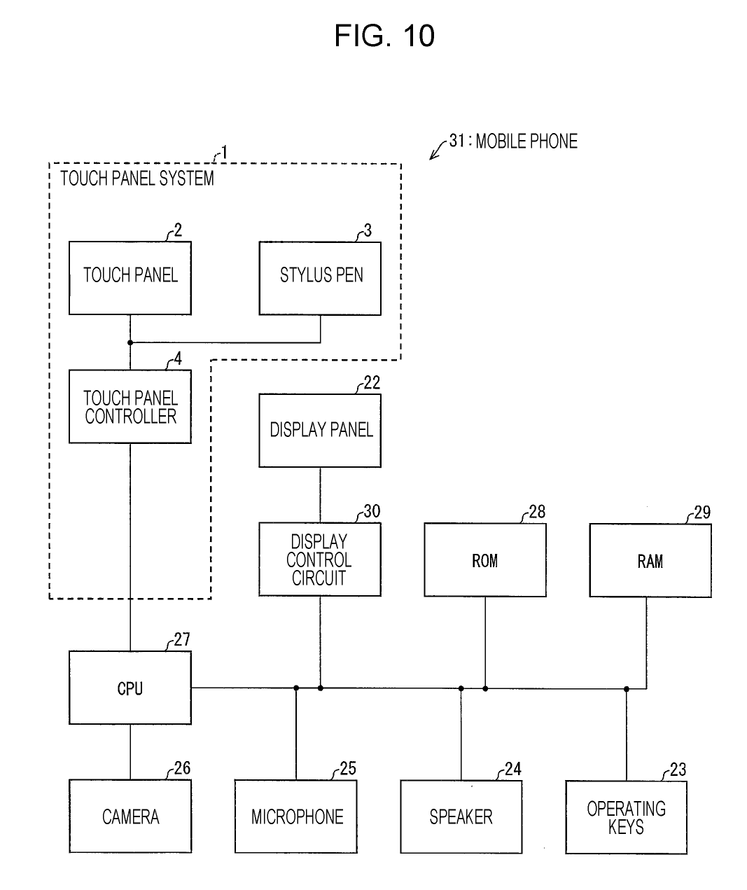

Another embodiment of the present invention is described as follows on the basis of FIG. 10. Note that, for the sake of convenience, members having the same functions as members described in the foregoing embodiments are denoted with the same signs, and description thereof will be reduced or omitted.

FIG. 10 is a function block diagram illustrating a configuration of a mobile phone 31 (electronic device) given as an example of an electronic device including the touch panel system 1 of Embodiment 1.

The mobile phone 31 is equipped with the touch panel system 1, a display panel 22, operating keys 23, a speaker 24, a microphone 25, a camera 26, a central processing unit (CPU) 27, read-only memory (ROM) 28, random access memory (RAM) 29, and a display control circuit 30. The respective structural elements of the mobile phone 31 are interconnected via a data bus.

As discussed earlier, the touch panel system 1 is equipped with the touch panel 2, the stylus pen 3, and the touch panel controller 4.

The display panel 22 displays images stored in the ROM 28 or the RAM 29. The operation of the display panel 22 is controlled by the display control circuit 30.

The display panel 22 may be overlaid with the touch panel 2, or built into the touch panel 2. Note that a touch recognition signal generated by a touch recognition unit and indicating a touch position on the touch panel 2 may also fulfill the same role as a signal indicating that the operating keys 23 have been operated.

The operating keys 23 accept input operations performed by the user on the mobile phone 31. The speaker 24 outputs sound, based on music data or the like stored in the ROM 28 or the RAM 29, for example.

The microphone 25 accepts sound or voice input from the user. The mobile phone 31 digitizes the input sound (analog data). Subsequently, the mobile phone 31 transmits the digitized sound to a communication peer (for example, another mobile phone).

The camera 26 captures a photographic subject according to input operations by the user on the operating keys 23, and generates image data. Note that the image data is stored in the ROM 28, the RAM 29, or auxiliary memory (for example, a memory card).

The CPU 27 centrally controls the operations of the touch panel system 1 and the mobile phone 31. The CPU 27 also executes various programs stored in the ROM 28, for example.

The ROM 28 stores data in a non-volatile manner. Also, the ROM 28 is ROM capable of writing and erasing data, such as erasable programmable ROM (EPROM) or flash memory. Note that, although not illustrated in FIG. 10, the mobile phone 31 may also be configured to include an interface for connecting to another electronic device in a wired manner.

The RAM 29 stores, in a volatile manner, data generated by the execution of programs by the CPU 27, or data input via the operating keys 23.

The mobile phone 31 equipped with the touch panel system 1 likewise exhibits effects similar to the touch panel system 1 of the embodiments discussed earlier.

Note that in the present embodiment, the mobile phone 31 given as an example of an electronic device provided with the touch panel system 1 is a camera-equipped mobile phone, smartphone, or the like, the electronic device provided with the touch panel system 1 is not limited thereto. For example, mobile terminal devices such as tablets, and information processing devices such as PC monitors, signage, electronic blackboards, and information displays likewise are included in the electronic device provided with the touch panel system 1.

### CONCLUSION

A touch panel controller according to a first aspect of the present invention is a touch panel controller that outputs, to a touch panel, a synchronization signal acquired by a stylus pen at a certain timing, characterized in that the touch panel controller generates a preparation signal including a high state and a low state that acts as a reference for adjusting a reception sensitivity of the synchronization signal in the stylus pen, and outputs the preparation signal to the touch panel earlier than the timing at which to output the synchronization signal to the touch panel.

According to the above configuration, the touch panel controller generates a preparation signal including a high state and a low state that acts as a reference for adjusting the reception sensitivity of the synchronization signal in the stylus pen, and outputs the preparation signal to the touch panel earlier than the timing at which to output the synchronization signal to the touch panel.

Consequently, the stylus pen is able to use the preparation signal including a high state and a low state that acts as a reference for adjusting the reception sensitivity of the synchronization signal output from the touch panel controller, and thus a touch panel controller capable of minimizing the possibility of the stylus pen failing to detect the synchronization signal may be realized.

In a touch panel controller according to a second aspect of the present invention, preferably, the preparation signal is a signal determining the timing at which the synchronization signal is acquired by the stylus pen.

According to the above configuration, the touch panel controller outputs, to the touch panel, the preparation signal that acts as a reference for adjusting the reception sensitivity of the synchronization signal in the stylus pen, and also determines a timing at which the synchronization signal is acquired in the stylus pen.

Consequently, since the stylus pen is able to use such a preparation signal, a touch panel controller capable of minimizing the possibility of the stylus pen failing to detect the synchronization signal may be realized.

In a touch panel controller according to a third aspect of the present invention, preferably, the preparation signal is a signal that includes information about a period of a unit signal constituting the synchronization signal, or a phase of the synchronization signal.

According to the above configuration, the touch panel controller outputs, to the touch panel, the preparation signal that acts as a reference for adjusting the reception sensitivity of the synchronization signal in the stylus pen, and which may be used to determine the high or low of the synchronization signal when determining the timing at which the synchronization signal is acquired in the stylus pen.

Consequently, since the stylus pen is able to use such a preparation signal, a touch panel controller capable of minimizing the possibility of the stylus pen failing to detect the synchronization signal may be realized.

A touch panel system according to a fourth aspect of the present invention is a touch panel system provided with a stylus pen, a touch panel, and a touch panel controller that outputs, to the touch panel, a synchronization signal acquired by the stylus pen at a certain timing, characterized in that the touch panel controller generates a preparation signal including a high state and a low state, and outputs the preparation signal to the touch panel earlier than the timing at which to output the synchronization signal to the touch panel, and the stylus pen is equipped with a synchronization signal reception adjustment circuit that adjusts a reception sensitivity of the synchronization signal in the stylus pen during a reception interval of the preparation signal, based on the received preparation signal.

According to the above configuration, the touch panel controller generates a preparation signal including a high state and a low state, and outputs the preparation signal to the touch panel earlier than the timing at which to output the synchronization signal to the touch panel. Additionally, the stylus pen is equipped with a synchronization signal reception adjustment circuit that adjusts the reception sensitivity of the synchronization signal in the stylus pen during a reception interval of the preparation signal, based on the received preparation signal.

Consequently, the stylus pen is able to adjust the reception sensitivity of the synchronization signal in the stylus pen during the reception interval of the preparation signal based on the received preparation signal, and thus a touch panel system capable of minimizing the possibility of the stylus pen failing to detect the synchronization signal may be realized.

In a touch panel system according to a fifth aspect of the invention, the preparation signal is a signal determining the timing at which the synchronization signal is acquired by the stylus pen, and the synchronization signal reception adjustment circuit may be configured to adjust, during the reception interval of the preparation signal, the reception sensitivity of the preparation signal and the synchronization signal to receive, based on the received preparation signal.

According to the above configuration, in the synchronization signal detection circuit, a suitable acquisition timing is generated based on the received preparation signal, and consistent detection of the synchronization signal may be conducted. Thus, a touch panel system capable of minimizing the possibility of the stylus pen failing to detect the synchronization signal may be realized.

In a touch panel system according to a sixth aspect of the present invention, the preparation signal is a signal that includes information about a period of a unit signal constituting the synchronization signal, or a phase of the synchronization signal, and the synchronization signal reception adjustment circuit may be configured to adjust, during the reception interval of the preparation signal, the reception sensitivity of the preparation signal and the synchronization signal to receive, based on the received preparation signal.

According to the above configuration, in the synchronization signal detection circuit, a suitable acquisition timing is generated based on the received preparation signal. Additionally, the received preparation signal may also be used to determine the high or low of the synchronization signal. Consequently, consistent detection of the synchronization signal may be conducted, and a touch panel system capable of minimizing the possibility of the stylus pen failing to detect the synchronization signal may be realized.

A stylus pen according to a seventh aspect of the present invention is a stylus pen that acquires a synchronization signal of a touch panel at a certain timing, characterized by comprising: a synchronization signal reception adjustment circuit that receives a preparation signal at a timing earlier than the synchronization signal, and adjusts a reception sensitivity of the synchronization signal during a reception interval of the preparation signal, based on the received preparation signal.

According to the above configuration, there is provided a synchronization signal reception adjustment circuit that receives a preparation signal at a timing earlier than the synchronization signal, and adjusts the reception sensitivity of the synchronization signal during a reception interval of the preparation signal, based on the received preparation signal.

Consequently, the stylus pen is able to adjust the reception sensitivity of the synchronization signal in the stylus pen during the reception interval of the preparation signal based on the received preparation signal, and thus a stylus pen capable of minimizing the possibility of failing to detect the synchronization signal may be realized.

In a stylus pen according to an eighth aspect of the present invention, preferably, the synchronization signal reception adjustment circuit adjusts, during the reception interval of the preparation signal, the reception sensitivity of the preparation signal and the synchronization signal to receive, based on the received preparation signal.

According to the above configuration, the stylus pen is able to detect the synchronization signal consistently, and thus a stylus pen capable of minimizing the possibility of the stylus pen failing to detect the synchronization signal may be realized.

An electronic device according to a ninth aspect of the present invention is provided with the touch pen, the touch panel controller, or the touch panel system.

Note that the present invention is not limited to the embodiments discussed above, and various modifications are possible within the scope indicated by the claims. Embodiments obtained by appropriately combining the technical means respectively disclosed in different embodiments are also included within the technical scope of the present invention.

### INDUSTRIAL APPLICABILITY

The present invention may be used favorably in a touch panel system equipped with a touch panel, a touch panel controller, and a stylus pen.

### REFERENCE SIGNS LIST

1 touch panel system
2 touch panel
3 stylus pen
4 touch panel controller
5 drive line driving circuit
6 sense amplifier
7 timing generator
8 preparation signal generation unit
9 AD converter
10 processing unit
11 pen body
11a grip portion
12 pen tip portion
12a pen tip cover
12b pen tip shaft
12c insulator
12d pen pressure sensor
13 connection switch
14 control circuit
15a operation toggle switch
15b operation toggle switch
16 sense circuit
17 synchronization signal reception adjustment circuit
18 synchronization signal detection circuit
19 timing adjustment circuit
20 drive circuit
21a first operating switch
21b second operating switch
31 mobile phone (electronic device)
Cₙₘ capacitor
Dₙ drive line
Sₘ sense line

1. A touch panel controller that outputs, to a touch panel, a synchronization signal acquired by a stylus pen at a certain timing, characterized in that
the touch panel controller generates a preparation signal including a high state and a low state that acts as a reference for adjusting a reception sensitivity of the synchronization signal in the stylus pen, and outputs the preparation signal to the touch panel earlier than the timing at which to output the synchronization signal to the touch panel.

2. The touch panel controller according to claim 1, characterized in that
the preparation signal is a signal determining the timing at which the synchronization signal is acquired by the stylus pen.

3. The touch panel controller according to claim 1, characterized in that
the preparation signal is a signal that includes information about a period of a unit signal constituting the synchronization signal, or a phase of the synchronization signal.

4. A touch panel system provided with a stylus pen, a touch panel, and a touch panel controller that outputs, to the touch panel, a synchronization signal acquired by the stylus pen at a certain timing, characterized in that
the touch panel controller generates a preparation signal including a high state and a low state, and outputs the preparation signal to the touch panel earlier than the timing at which to output the synchronization signal to the touch panel, and
the stylus pen is equipped with a synchronization signal reception adjustment circuit that adjusts a reception sensitivity of the synchronization signal in the stylus pen during a reception interval of the preparation signal, based on the received preparation signal.

5. A stylus pen that acquires a synchronization signal of a touch panel at a certain timing, characterized by comprising:
a synchronization signal reception adjustment circuit that receives a preparation signal at a timing earlier than the synchronization signal, and adjusts a reception sensitivity of the synchronization signal during a reception interval of the preparation signal, based on the received preparation signal.
